(19) United States
(12) Patent Application Publication
(10) Pub. No.: US 2007/0039744 A1
(43) Pub. Date: Feb. 22, 2007

(54) Tunnel fire protection system

(75) Inventor: Rudy M. Pavesi, Old Tappan, NJ (US)

Correspondence Address: FRISHAUF, HOLTZ, GOODMAN & CHICK, PC, 220 Fifth Avenue, 16TH Floor, NEW YORK, NY, 10001-7708, US

(73) Assignee: FIREAWAY LLC, Minnetonka, MN (US)

(21) Appl. No.: 11/298,899

(22) Filed: Dec. 9, 2005

Related U.S. Application Data
(60) Provisional application No. 60/710,644, filed on Aug. 22, 2005.

(51) Int. Cl. A62C 8/00; A62C 3/00; E21F 5/10

(52) U.S. Cl. 169/49; 169/54; 169/64

(57) ABSTRACT

Tunnel fire protection system for isolating and suppressing fires in a tunnel includes a fire detecting arrangement arranged in the tunnel for detecting a fire, curtain assemblies spaced apart from one another in an axial direction of the tunnel to partition it into zones and a control unit coupled to the fire detecting arrangement and the curtain assemblies for directing the release of curtains from the curtain assemblies based on the detection of a fire. In this manner, a tunnel fire can be isolated in a zone between a pair of barriers formed by the curtains upon their release. To suppress the fire, fire extinguisher units are arranged on the tunnel walls, with at least one in each zone, and those in the zone in which the fire is detected are activated by the control unit. The fire extinguisher units may be aerosol-type fire extinguishers.

### CROSS-REFERENCE TO RELATED APPLICATION

This application claims priority under 35 U.S.C. 119(e) of U.S. provisional patent application Ser. No. 60/710,644 filed Aug. 22, 2005, which is incorporated by reference herein.

### FIELD OF THE INVENTION

The present invention relates to a fire protection system for tunnels and a system and method for detecting and reacting to a fire in a tunnel to minimize loss of life and expedite extinguishing of the fire.

The present invention also relates to a method for isolating a fire in tunnel and a method for detecting the location of a fire in a tunnel.

### BACKGROUND OF THE INVENTION

Of all different types of fires, tunnel fires likely have the greatest potential for significant loss of life in view of several factors unique to tunnels. These factors include the inherent confining area of the tunnel which increases the intensity of the fire, the lack of natural ventilation in the tunnel to disperse smoke, gases and heat generated by the fire, the restricted egress from the tunnel for people trapped by the fire, and people's unfamiliarity with the presence and location of emergency exits in the tunnel, if any. Indeed, in view of construction and cost factors, there are often an insufficient number of emergency exits in a tunnel to allow for egress of a typical number of people trapped in the tunnel by a fire.

One common scenario which gives rise to an extremely dangerous tunnel fire is when a single vehicle, a car or truck, catches fire inside the tunnel, possibly by crashing into a tunnel wall or into another vehicle. This single vehicle may block traffic through the tunnel in one or both directions requiring other vehicles to stop inside the tunnel. Some of these stopped vehicles may be in close proximity to the vehicle on fire and may also catch fire as the fire in the original vehicle spreads, e.g., flaming parts of the original vehicle may contact these stopped vehicles and ignite them or fuel may spill from the original vehicle causing the stopped vehicles' fuel tanks to explode. This would create a chain reaction of fires and explosions inside the tunnel which would be significantly more severe than the original vehicular accident.

Another problem prevalent in tunnel fires is that the fires generated by burning vehicles produce dense clouds of smoke and harmful gases because the flammable material in the vehicles includes, inter alia, fuel, oil, tires, rubber and synthetic materials. Moreover, since these materials may burn at a temperature as high as 1400° F., an excessive amount of heat is generated in the tunnel. The smoke, gases and heat make it difficult for the people exiting from vehicles stopped in the tunnel to breathe and to find their way to emergency exits.

Still another problem of a tunnel fire is that it is often difficult for first responders, e.g., fire department personnel, to reach the site of the original fire or subsequently generated fires in a timely manner in order to begin extinguishing the fires. Unfortunately, the fire personnel must often exit their vehicles close to an entrance to the tunnel in view of the presence of stopped vehicles between the tunnel entrance and the site of the fires and people exiting the tunnel to escape from the fire. The fire personnel must therefore carry portable firefighting equipment into the tunnel to the site of the fires in order to be able to begin to fight the fires. This delay further increases the likelihood of the loss of life of people trapped in the tunnel.

Another possible problem arises if the tunnel fire is not extinguished quickly enough. In this case, the tunnel may suffer structural damage which may further complicate efforts to reach and extinguish the fire.

### OBJECTS AND SUMMARY OF THE INVENTION

It is an object of the present invention to provide a new and improved fire protection system for tunnels which detects a fire in the tunnel, isolates the fire and thereafter attempts to suppress the fire.

It is another object of the present invention to provide a new and improved method for detecting the location of a fire in a tunnel and preferably thereafter isolating the fire.

It is yet another object of the present invention to provide a new and improved system and method for detecting and reacting to a fire in a tunnel to minimize loss of life and expedite extinguishing of the fire. The reaction may be a variable real-time reaction which depends on the detected location of the fire.

In order to achieve these objects and others, a tunnel fire protection system in accordance with the invention includes a fire detecting arrangement arranged in the tunnel for detecting a fire in the tunnel, a plurality of curtain assemblies spaced apart from one another in an axial direction of the tunnel and each including a releasable curtain arranged to drop toward a bottom of the tunnel, and a control unit coupled to the fire detecting arrangement and the curtain assemblies for directing the release of the curtains based on the detection of a fire. By means of the invention, a tunnel fire can be isolated in a “zone” between a pair of barriers formed by the curtains upon their release. That is, the curtains immediately before and after the fire are released to thereby trap and contain the fire between the curtains. Therefore, the fire cannot spread beyond the curtains to other zones in the tunnel.

Moreover, to begin suppressing the fire, fire extinguisher units are arranged on the tunnel walls, with at least one being in each zone. The fire extinguisher units are activated by the control unit upon detection of a fire, and specifically, only those fire extinguisher units in the zone in which the fire is detected are activated. The fire extinguisher units may comprise one or more fire extinguishers, for example, aerosol-type fire extinguishers.

Each curtain assembly includes weighted ceramic curtains in a folded or compacted form and, after being released, laterally overlap one another across substantially the entire width of the tunnel to thereby form the barrier. The curtains preferably have a length so that they extend proximate to or in contact with the bottom of the tunnel.

The fire detecting arrangement includes smoke detectors, thermal detectors and infrared cameras or other sensors which are capable of detecting either a fire or a condition resulting from the fire, e.g., heat, combustion gases or smoke.

Enhancements to the fire protection system include the mounting of speakers in the tunnel to enable messages relating to responses to the fire to be provided to people in the tunnel upon detection of a fire, and strobe lights in the tunnel which are activated upon detection of a fire.

In a method for detecting and reacting to a fire in a tunnel in accordance with the invention, fire extinguishers and curtain assemblies are arranged at multiple locations along substantially the entire length of the tunnel. Upon detecting the location of the fire in the tunnel, specific fire extinguishers are activated based on the detected location of the fire and the curtains of one or more of the curtain assemblies is/are released based on the detected location of the fire.

As to the determination as to which curtains to release, the tunnel can be partitioned by the curtain assemblies into zones, each formed between a pair of curtain assemblies, so that only those curtain assemblies which define the zone in which the fire is detected, i.e., the curtain assembly immediately before the fire and the curtain assembly immediately after the fire, are directed to release their curtains. In a similar manner, only those fire extinguishers which generate fire suppression agent in the zone in which the fire is located are activated. This eliminates unnecessary curtain deployment and fire extinguisher activation.

Variations in the method in order to aid evacuation of people from the tunnel and/or fire and rescue personnel to perform rescue and fire-fighting operations include arranging speakers and strobe lights at multiple locations in the tunnel and generating audio messages via the speakers relating to desired actions by people in the tunnel and activating the strobe lights upon detection of a fire.

The location of the fire can be detected by sensors at multiple locations along the axial length of the tunnel, the sensors being of the type described above. The location of each sensor is associated with its identification such that upon generation of a signal from the sensor indicative of a fire or fire condition, an approximate location of the fire is determinable since the location of the sensor generating the signal is known.

Alternatively, to allow for automatic deployment of the fire extinguishers, a fire-detecting or fire-condition detecting sensor may be arranged in connection with each fire extinguisher which would then be automatically activated whenever the associated fire-detecting or fire-condition detecting sensor detects a fire or fire condition.

A method for isolating a fire in a tunnel in accordance with the invention includes arranging curtain assemblies at multiple locations in the tunnel, each curtain assembly being as described above, and releasing the curtains from at least one curtain assembly based on the detected location of the fire. The curtain assemblies can be spaced apart from one another to form zones in the tunnel between each adjacent pair of curtain assemblies, in which case, the curtains are released from the curtain assemblies defining the zone in which the fire is detected. In this regard, the extreme zones, i.e., the zone at each end of the tunnel, may be defined by only a single curtain assembly with the other end of the zone being an entrance to the tunnel. The fire can be detected by the various sensors mentioned above.

A method for detecting the location of a fire in a tunnel in accordance with the invention includes partitioning the tunnel into a plurality of axial zones, arranging fire-detecting or fire-condition detecting sensors at multiple locations along the axial length of the tunnel such that at least one sensor is arranged in each zone, and associating the zone in which each sensor is located with its identification such that upon generation of a signal from the sensor indicative of a fire, the zone of the sensor is known and thus an approximate location of the fire is determinable.

### BRIEF DESCRIPTION OF THE DRAWINGS

The invention, together with further objects and advantages thereof, may best be understood by reference to the following description taken in conjunction with the accompanying drawings, wherein like reference numerals identify like elements, and wherein:

FIG. 1 is a cross-sectional view of a tunnel showing part of the tunnel fire protection system in accordance with the invention.

FIG. 2 is a cross-sectional view of the tunnel taken along the line 2-2 of FIG. 1.

FIG. 3 is a schematic showing major components of a tunnel fire protection system in accordance with the invention.

FIG. 4 shows is a cross-section view of an example of a fire extinguishing unit used in the invention.

### DETAILED DESCRIPTION OF THE INVENTION

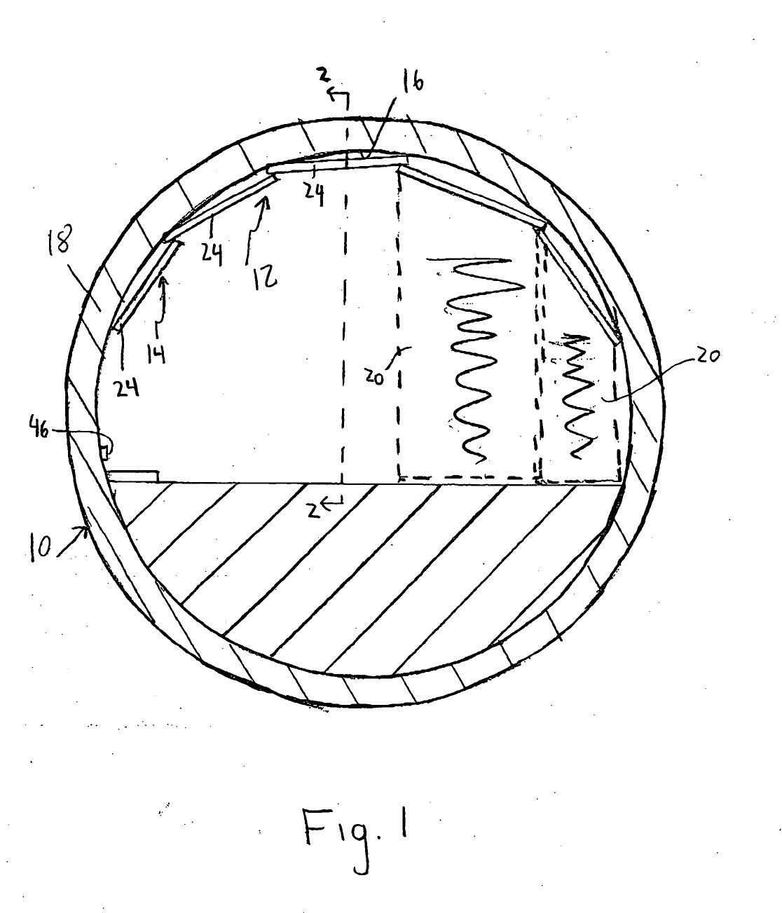

Referring to the accompanying drawings wherein like reference numerals refer to the same or similar elements, FIG. 1 shows a transverse cross-section of a tunnel 10 in which the fire protection system 12 in accordance with the invention is installed. One of the primary objectives of the tunnel fire protection system 12 is to isolate or confine a fire in the tunnel 10 by creating a barrier to the spread of the fire and smoke, heat and gases generated thereby. To this end, a series of curtain assemblies 14 are placed in the tunnel 10 at different axial locations.

A tunnel zone is defined between each adjacent pair of curtain assemblies 14, as well as between the ends of the tunnel 10 and the curtain assemblies at the extreme ends of the tunnel 10. The designation of such zones is used to detect the location of a fire for the purpose of determining an optimal reaction to the fire.

As shown in FIG. 1, each curtain assembly 14 is mounted to a ceiling 16 of the tunnel 10, which may be an upper part of the tunnel wall 18. Each curtain assembly 14 includes weighted ceramic curtains 20, each in a folded or compacted form in a pre-release state. The curtains 20 are arranged such that their lateral edges overlap one another after they are released, and have a predetermined length so that they extend close to or possibly in contact with the bottom of the tunnel 10 after full expansion (in FIG. 1, two curtains 20 on the right side are shown in a release state). The overlapping curtains 20 form a barrier at an axial location of the tunnel 10 which inhibits smoke, heat and gas from passing therethrough.

Curtains 20 are maintained in their folded or compact form in each curtain assembly 14 until the presence of a fire is detected. Upon detection of a fire, the curtains 20 from the curtain assemblies 14 immediately in front of and immediately behind the axial location of the tunnel 1—at which the fire is detected are released and would then drop, in view of their weighting, to the bottom of the tunnel 10 to isolate or confine the fire between the released curtains 20. Thus, if the fire is detected at a location immediately in front of a curtain assembly 14, upon release of the curtains 20, people in an area of the tunnel 10 behind the curtain assembly 14 will not be encumbered by the fire and the smoke, heat and gases being generated thereby. These people should therefore be able to locate emergency exits and exit safely from the tunnel 10.

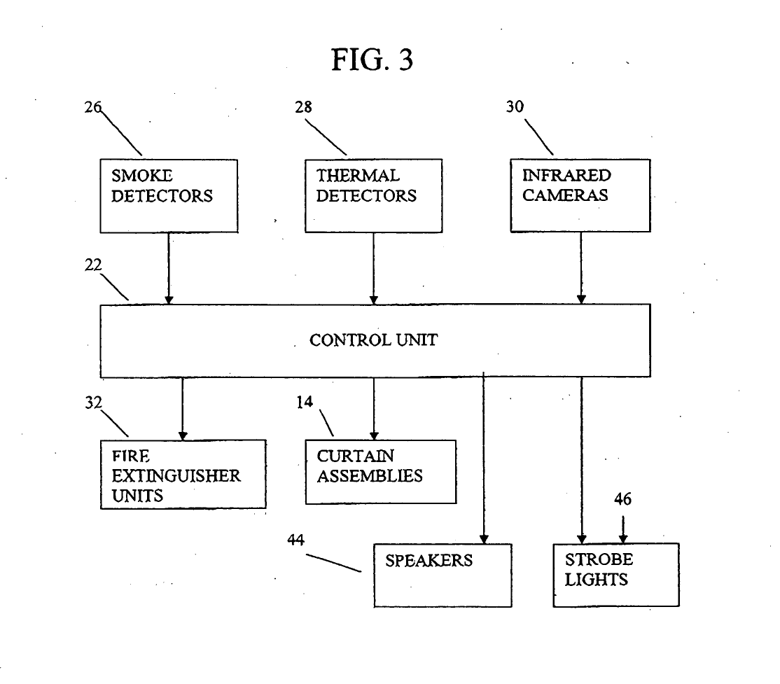

Release of the curtains 20 can be performed in various ways, for example, electronically by means of a control unit 22, discussed in detail below with reference to FIG. 3.

Each curtain assembly 14 includes optional housings 24, each containing a single curtain 20. Housings 24 are mounted to the ceiling 16 of the tunnel wall 18 at a plurality of location along the axial length of the tunnel 10. Housing 24 protect the curtains 20 from damage that might be caused by the environment in the tunnel 10. To enable release of the curtains 20 from the housings 24, housings 24 are provided with a deployment door which is released upon receipt of a command signal from the control unit 22 indicating that a fire is present in a tunnel segment immediately in front of or immediately behind the location at which the curtain assembly 14 is located.

The spacing between the curtain assemblies 14 can be selected as desired by the protection system designer, e.g., 50 feet or 100 feet. The width of the curtains 16, and thus the optional housings 24 therefor, can be selected as desired and in one possible construction, the curtains 20 each have a width of about 3 feet.

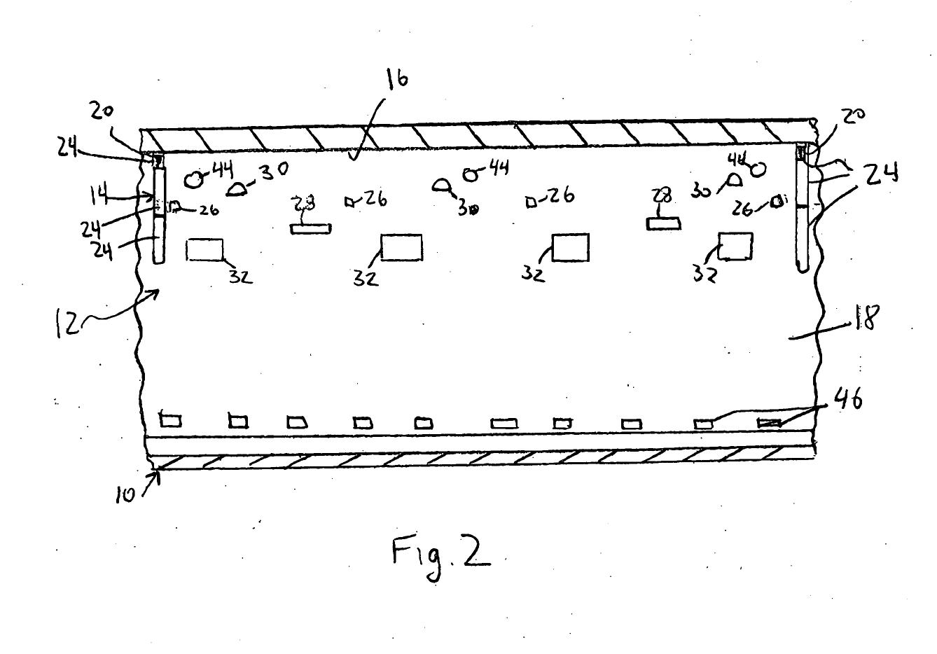

Referring now to FIGS. 2 and 3, the fire protection system 12 includes sensors 26, 28, 30 which detect the presence and location of a fire in the tunnel, or conditions indicative of a fire, e.g., smoke, heat or specific combustion gases. These sensors 26, 28, 30 are mounted to the tunnel wall 18 or stationary supports in the tunnel 10 at various locations in the tunnel 10. Each type of sensor may be substantially equally spaced along the tunnel 10, e.g., every 100 feet or so.

A first type of sensor 26 is a smoke detector which detects smoke. A second type of sensor 28 is a thermal detector which detects heat. A third type of sensor 30 is an infrared camera which detects infrared radiation which can be analyzed to determine the presence of a fire. Sensors 30 may be closed circuit television cameras. Additional types of fire-detecting or fire condition detecting sensors, which detect or provide data which can be analyzed to detect a fire or detect or provide data which can be analyzed to detect conditions of a fire such as smoke, heat and combustion gases, can be used in the system 12.

Sensors 26, 28, 30 are coupled to a control unit 22, e.g., through a wired connection along or in the tunnel wall 18 or wirelessly. Control unit 22 receives signals from the sensors 26, 28, 30 indicative of a fire, smoke, heat or combustion gases, or data from the sensors 26,28, 30 which is analyzed by software in a memory of the control unit 22 to determine the presence of a fire or smoke, heat or combustion gases indicative of a fire. Control unit 22 thus determines the existence of a fire in the tunnel 10 based on the signals from sensors 26, 28, 30.

Control unit 22 can be designed to associate location data with each sensor 26, 28, 30 so that the signals or data provided by each sensor 26, 28, 30 to the control unit 22 is/are associated with the location of the sensor. In this manner, the control unit 22 is able to determine where the fire is located based on which sensors 26, 28, 30 register the presence of the fire or conditions indicative of the fire. The location of the fire could be determined relative to one end of the tunnel 10, i.e., a determination is made that the fire is located 850 feet from one end of the tunnel 10, or designated zones of the tunnel 10 so that the location of the fire would be in one (or more) of the zones. As noted above, the zones can be defined between each adjacent pair of curtain assemblies 14.

Fire protection system 12 also includes a system for suppressing the fire once its location is determined. Specifically, fire protection system 12 includes fixed fire extinguisher unit 32 mounted on the tunnel wall 18. Although only one side of the tunnel wall 18 is shown in FIG. 2, the opposite side of the tunnel wall 18 could be similar equipped with sensors 26, 28, 30 and/or fire extinguisher units 32. Preferably, both sides of the tunnel wall 18 are equipped with fire extinguisher units 32.

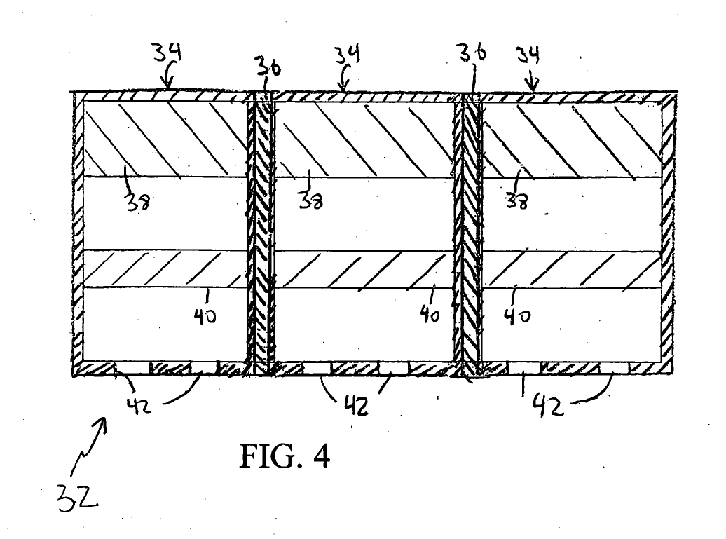

Fire extinguisher units 32 can be any type of fire extinguisher device which is remotely activated to generate a fire suppression agent, such as an aerosol generator-type of fire extinguisher. An exemplifying fire extinguisher unit 32 is shown in FIG. 4 and comprises three aerosol extinguishers 34 arranged side-by-side and separated from one another by a ceramic divider 36. Each aerosol extinguisher 34 include a combustible aerosol-forming compound 38 and a block of oxidation and/or cooling material 40 arranged between the aerosol-forming compound 38 and discharge ports 42. Possible aerosol-forming compounds for use in the invention include those described in U.S. Pat. Nos. 5,831,209, 6,042,664, 6,264,772 and 6,689,285 (all of which are assigned to R-Amtech International, Inc.). Alternative aerosol extinguishers for use in the present invention are disclosed in U.S. patent application Ser. Nos. 11/234,733 and 11/234,625, the entire disclosure of each of which is incorporated herein by reference.

The fire extinguisher units 32 including three aerosol extinguishers 34 can be spaced a distance of, for example, 5 feet from one another. The capacity of the aerosol extinguishers 34 and spacing of the fire extinguisher units 32 from one another can depend on several factors, including, for example, the width and height of the tunnel 10. Further, each aerosol extinguisher 34 can be designed to generate fire suppression agent at the rate of about 100 grams per cubic meter.

Since the fire suppression agent produced by an aerosol-type fire extinguisher can be harmful to people, control unit 22 can be designed to allow for a delay between the determination of the existence of a fire in the tunnel 10 via sensors 26, 28, 30 and the activation of the fire extinguisher units 32. This delay allows people not critically injured by the accident which gives rise to the fire to exit the area of the fire which is to be flooded with fire suppression agent from the aerosol extinguishers 34.

Once the location of the fire is determined by control unit 22, it not only determines which fire extinguisher units 32 should be activated, it also directs the release of the curtains 20 from the curtain assemblies 14 immediately in front of and behind the fire, i.e., to contain the fire within a tunnel segment or zone. The fire suppression agent can be generated by the fire extinguishers 34 substantially simultaneously with the release of the curtains 20. Alternatively, the curtains 20 could be released and a time delay provided before the activation of the aerosol extinguishers 34 to allow the curtains 20 to drop to a position close to or in contact with the bottom of the tunnel 10.

In addition to remotely activated fire extinguisher units 32 to aid in suppressing the fire, the fire protection system 12 also includes one or more systems to aid in enabling people in the tunnel 10 to exit from the tunnel 10. One system is a series of speakers 44 mounted to the tunnel wall 18 and coupled to the control unit 22. Control unit 22 can be designed to cause speakers 44 to provide a recorded message relating to evacuation of the tunnel 10 or a real-time message provided by an individual monitoring the control unit 22. In the latter case, the fire monitoring personnel can visualize the fire via sensors 30, view people in the tunnel 10 and provide specific directions for these people to the nearest emergency exit or tunnel entrance. In the case of recorded messages, the messages may be general messages designed to aid people to avoid the harmful effects of the fire, such as a message to stay low and move to the side of the tunnel or the messages might be directions to the nearest exit or actions to be undertaken to minimize the potential harm from the fire, smoke, heat or gases. Also, the speakers 44 could be used to warn people near the fire that the area around the fire is about to be flooded with fire suppression agent and therefore, they should leave that area immediately.

Another system which aids people to exit the tunnel 10 is a series of infrared strobe lights 46 arranged on the tunnel wall 18 and designed, for example, to indicate the direction to an exit out of the tunnel 10, e.g., an emergency exit. Strobe lights 46 illuminate a portion of tunnel 10 and will assist people in seeing the bottom of the tunnel 10 to enable them to flee the fire. Also, the strobe lights 46 can aid fire and rescue personnel when operating in the tunnel to suppress the fire and evacuate trapped people.

Control unit 22 controls the fire protection system 12 and to this end includes hardware and software to allow for communications with sensors 26, 28, 30 and for issuance of activation signals to curtain assemblies 14, fire extinguisher units 32, speakers 44 and strobe lights 46. The connections to and from control unit 22 may be by means of wired connections or wireless connections. Control unit 22 may be situated inside or outside of the tunnel 10.

Control unit 22 processes the input from the sensors 26, 28, 30 to analyze whether the sensors 26, 28, 30 indicate the presence of a fire in one of the tunnel zones. This analysis can be aided by associating each sensor 26, 28, 30 with an indication of the zone in which it is located. Thus, detection of a fire by one of the sensors 26, 28, 30 will enable the control unit 22 to consider the location of the fire to be in the zone in which that sensor is located. Once the zone in which a fire is detected is known, the control unit 22 directs activation signals to the curtain assemblies 14 at the ends of that zone, to the fire extinguisher units 32 in that zone, to speakers 44 and to strobe lights 46. Activation of the fire extinguisher units 32 is therefore electronic and automatic based on the detection of a fire via one or more of the sensors 26, 28, 30. The activation of the speakers 44 and strobe lights 46 does not have to be limited only to the zone in which a fire is detected but may be a plurality of zones or all zones since the messages provided from speakers 44 and light provided by strobe lights 46 may be needed by people in zones other then the one with the fire and the lights from strobe lights 46 are useful to fire and rescue personnel.

Control unit 22 can also be programmed to alert a manned fire and rescue facility about the existence of a tunnel fire 10. To this end, the control unit could include a communications device.

Instead of automatic activation of the fire extinguisher units 32 via control unit 22, a system for providing thermal and/or manual activation of the fire extinguisher units 32 can be provided. In a thermally activated system, a fire-detecting or fire-condition detecting sensor is arranged in connection with each fire extinguisher unit 32 or aerosol extinguisher 34. When this sensors detects a fire or fire condition, e.g., heat in excess of a threshold, the aerosol extinguisher 34 is activated.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention.

1. A tunnel fire protection system, comprising:
fire detecting means adapted to be arranged in the tunnel for detecting a fire in the tunnel;
a plurality of curtain assemblies spaced apart from one another in an axial direction of the tunnel, each of said curtain assemblies including at least one releasable curtain arranged to drop toward a bottom of the tunnel and extend across the width of the tunnel; and
a control unit coupled to said fire detecting means and said curtain assemblies for directing the release of said at least one curtain from said curtain assemblies based on the detection of a fire by said fire detecting means.

2. The system of claim 1, wherein said fire detecting means comprise a plurality of sensors arranged along the tunnel wall at multiple axial locations, said control unit being arranged to determine the location of the fire from signals provided by said sensors and direct the release of said curtain assemblies based on the determined location of the fire.

3. The system of claim 2, wherein said sensors are selected from a group consisting of smoke detectors, thermal detectors and infrared cameras.

4. The system of claim 1, wherein each of said curtain assemblies includes a plurality of weighted ceramic curtains in a folded or compact form and arranged to laterally overlap one another after being released to thereby form a barrier to the fire.

5. The system of claim 1, wherein the tunnel is partitioned by said curtain assemblies into zones, said control unit is arranged to determine the zone in which the fire is detected based on signals from said fire detecting means and direct release of said at least one curtain from said curtain assemblies at each end of said zone.

6. The system of claim 1, wherein said control unit is arranged to determine the location of the fire from signals provided by said fire detecting means, further comprising a plurality of fire extinguisher units adapted to be arranged in the tunnel at different axial locations, said control unit being coupled to said fire extinguisher units and arranged to control activation of said fire extinguisher units based on the determined location of the fire in the tunnel.

7. The system of claim 6, wherein said fire extinguisher units each comprise a plurality of aerosol-type fire extinguishers.

8. The system of claim 6, wherein said control unit is arranged to direct the release of said at least one curtain from said curtain assemblies based on the determined location of the fire.

9. The system of claim 1, further comprising speakers adapted to be arranged in the tunnel and coupled to said control unit, said control unit being arranged to cause speakers to provide messages relating to responses to the fire upon detection of a fire by said fire detecting means.

10. The system of claim 1, further comprising strobe lights adapted to be arranged in the tunnel and coupled to said control unit, said control unit being arranged to activate said strobe lights upon detection of a fire by said fire detecting means.

11. A method for isolating a fire in a tunnel, comprising:
arranging curtain assemblies at multiple locations in the tunnel, each curtain assembly including at least one releasable curtain which forms a barrier across the width of the tunnel when released;
detecting the location of the fire in the tunnel; and
releasing the at least one curtain from at least one curtain assembly based on the detected location of the fire.

12. The method of claim 11, further comprising forming zones between adjacent pairs of curtain assemblies, the step of detecting the location of the fire comprising detecting the zone in which the fire is located, the step of releasing the at least one curtain comprising releasing the at least one curtain from the curtain assemblies defining the zone in which the fire is detected.

13. The method of claim 12, wherein the step of detecting the location of the fire comprises arranging sensors at multiple locations along the axial length of the tunnel, the sensors being selected from a group consisting of smoke detectors, thermal detectors and infrared cameras, and associating the location of each sensor with its identification such that upon generation of a signal from the sensor indicative of a fire condition, an approximate location of the fire is determinable since the location of the sensor is known.

14. The method of claim 11, wherein each curtain assembly includes a plurality of weighted curtains, further comprising arranging the curtains to laterally overlap one another when released.

15. A method for detecting and reacting to a fire in a tunnel, comprising:
arranging fire extinguishers at multiple locations in the tunnel;
arranging curtain assemblies at multiple locations in the tunnel, each curtain assembly including at least one releasable curtain which forms a barrier across the width of the tunnel when released;
detecting the location of the fire in the tunnel;
activating specific fire extinguishers based on the detected location of the fire; and
releasing the at least one curtain from the curtain assemblies based on the detected location of the fire.

16. The method of claim 15, further comprising:
arranging speakers at multiple locations in the tunnel; and
generating audio messages via the speakers relating to desired actions by people in the tunnel.

17. The method of claim 15, wherein the fire extinguishers are aerosol-type fire extinguishers, further comprising forming fire extinguishing units from a plurality of the aerosol-type fire extinguishers.

18. The method of claim 15, further comprising forming zones between each adjacent pair of curtain assemblies, the step of detecting the location of the fire comprising detecting the zone in which the fire is located, the step of releasing the at least one curtain comprising releasing the at least one curtain only from the curtain assemblies defining the zone in which the fire is detected.

19. The method of claim 18, wherein the step of activating specific fire extinguishers comprises activating only those fire extinguishers which release fire suppression agent into the zone in which the fire is detected.

20. The method of claim 15, further comprising:
arranging strobe lights in the tunnel along the axial length of the tunnel; and
activating the strobe lights upon detection of a fire to facilitate egress of people from the tunnel and aid in manual efforts to extinguish the fire.

21. The method of claim 15, wherein the step of detecting the location of the fire comprises arranging sensors at multiple locations along the axial length of the tunnel, the sensors being selected from a group consisting of smoke detectors, thermal detectors and infrared cameras, and associating the location of each sensor with its identification such that upon generation of a signal from the sensor indicative of a fire condition, an approximate location of the fire is determinable since the location of the sensor is known.

22. The method of claim 15, wherein each curtain assembly includes a plurality of weighted curtains, further comprising arranging the curtains to laterally overlap one another when released.

23. The method of claim 15, wherein the step of detecting the location of the fire in the tunnel comprises arranging a fire-detecting or fire-condition detecting sensor in connection with each fire extinguisher such that each fire extinguisher is automatically activated whenever the associated fire-detecting or fire-condition detecting sensor detects a fire.

24. A method for detecting the location of a fire in a tunnel, comprising:
partitioning the tunnel into a plurality of axial zones;
arranging sensors at multiple locations along the axial length of the tunnel such that at least one sensor is arranged in each zone, the sensors being selected from a group consisting of smoke detectors, thermal detectors and infrared cameras; and
associating the zone in which each sensor is located with its identification such that upon generation of a signal from the sensor indicative of a fire, the zone of the sensor is known and thus an approximate location of the fire is determinable.
